(19) United States
(12) Patent Application Publication
(10) Pub. No.: US 2020/0023588 A1
(43) Pub. Date: Jan. 23, 2020

(54) SEALING ASSEMBLY FOR PACKAGING LINES

(71) Applicant: ILAPAK ITALIA S.P.A., FOIANO DELLA CHIANA (IT)

(72) Inventors: Daniele CIVOLANI, Molinella (IT); Francesco MARCHIONI, Bologna (IT)

(21) Appl. No.: 16/488,775

(22) PCT Filed: Feb. 15, 2018
(86) PCT No.: PCT/EP2018/053795

§ 371 Date: Aug. 26, 2019

(30) Foreign Application Priority Data
Feb. 24, 2017 (IT) 102017000020943

(51) Int. Cl. B29C 65/30; B29C 65/74; B29C 65/00

(52) U.S. Cl. CPC B29C 65/305; B29C 65/7451; B29C 66/4312; B65B 51/306; B29C 66/82263; B29C 66/849; B29C 66/8221

(57) ABSTRACT

A sealing assembly for packaging lines of the type having mutually opposite sealing heads between which the polymeric sheets to be mated translate, includes mutually opposite synchronously rotating carousels. At least two eccentric shafts are pivoted on each carousel, and at least one respective sealing head is pivoted on each one of the shafts at an axis. Each eccentric shaft includes a respective slider that can move along a fixed contoured profile for the movement of the respective shaft. A linkage connects corresponding levers which are substantially integral with the eccentric shafts. The levers are opposite to the point of coupling to the respective slider. Each sealing head is controlled by orientation elements which are integral with the respective carousel.

### TECHNICAL FIELD

The present disclosure relates to a sealing assembly for lines for the packaging of bags and/or blanks made of polymeric film or of any other laminar material of the type normally used for packaging.

### BACKGROUND

The provision of bags made of polymeric film, as well as the provision of any other type of blank that provides for the sealing of juxtaposed film flaps, is an extremely delicate industrial step.

In particular, the provision of bags by means of the process known as “flowpack” causes the action of sealing masses on the polymeric film during its advancement.

It is known to resort to mutually opposite rotating masses, which define extremely localized instantaneous sealing areas which are moreover affected by the sealing action for a limited time.

If the thickness of the film is considerable, serious problems in the efficiency of the entire line occur: in order to perform stable and complete sealing it is in fact necessary that the sealing masses act on the film for a sufficiently long time; however, long permanence times of the masses on the film would force a very low advancement speed of the film itself, which is not compatible with production requirements.

### SUMMARY

The aim of the present disclosure is to solve the problems described above, proposing a sealing assembly for packaging lines that ensures the execution of stable and complete seals.

Within this aim, the disclosure proposes a sealing assembly for packaging lines that allows the line in which it is installed to work with high speeds and therefore with high productivity.

The disclosure also proposes a sealing assembly for packaging lines that is particularly solid and scarcely subject to wear and failures.

The disclosure further proposes a sealing assembly for packaging lines that is protected effectively against the accidental entry of dust and debris.

The present disclosure provides a sealing assembly for packaging lines that has modest costs, is relatively simple to provide in practice and is safe in application.

This aim and these and other advantages which will become better apparent hereinafter are achieved by providing a sealing assembly for packaging lines of the type comprising mutually opposite sealing heads, between which the polymeric sheets to be mated translate, characterized in that it comprises mutually opposite synchronously rotating carousels, at least two eccentric shafts being pivoted on each carousel, at least one respective sealing head being pivoted on each one of said shafts at an axis, each eccentric shaft comprising a respective slider that can move along a fixed contoured profile for the movement of the respective shaft, a linkage connecting corresponding portions which are substantially integral with said eccentric shafts, said portions being opposite to the point of coupling to the respective slider, each sealing head being controlled by orientation elements which are integral with the respective carousel.

### BRIEF DESCRIPTION OF THE DRAWINGS

Further characteristics and advantages of the disclosure will become better apparent from the description of a preferred but not exclusive embodiment of the sealing assembly for packaging lines according to the disclosure, illustrated by way of nonlimiting example in the accompanying drawings, wherein:

FIG. 1 is a schematic view of the operation of the sealing assembly according to the disclosure;

FIGS. 2a, 2b, 2c, 2d, 2e, 2f, 2g, 2h, and 2i are schematic views of the operating sequence of the assembly of FIG. 1;

FIGS. 3a, 3b, 3c, 3d, 3e, 3f, 3g, 3h, and 3i are schematic views of the pattern of the generation of the trajectory of the assembly of FIG. 1;

FIGS. 4a, 4b, 4c, 4d, 4e, 4f, 4g, 4h, and 4i are schematic views of the pattern of the generation of the orientation of the sealing heads of the assembly of FIG. 1;

FIG. 5 is a top view of a possible embodiment of the sealing assembly according to the disclosure;

FIG. 6 is a sectional view, taken along the plane VI-VI outlined in FIG. 5;

FIG. 7 is a front view of the sealing assembly of FIG. 5; and

FIG. 8 is a partially sectional axonometric view of a portion of the sealing assembly of FIG. 5.

### DETAILED DESCRIPTION OF THE DRAWINGS

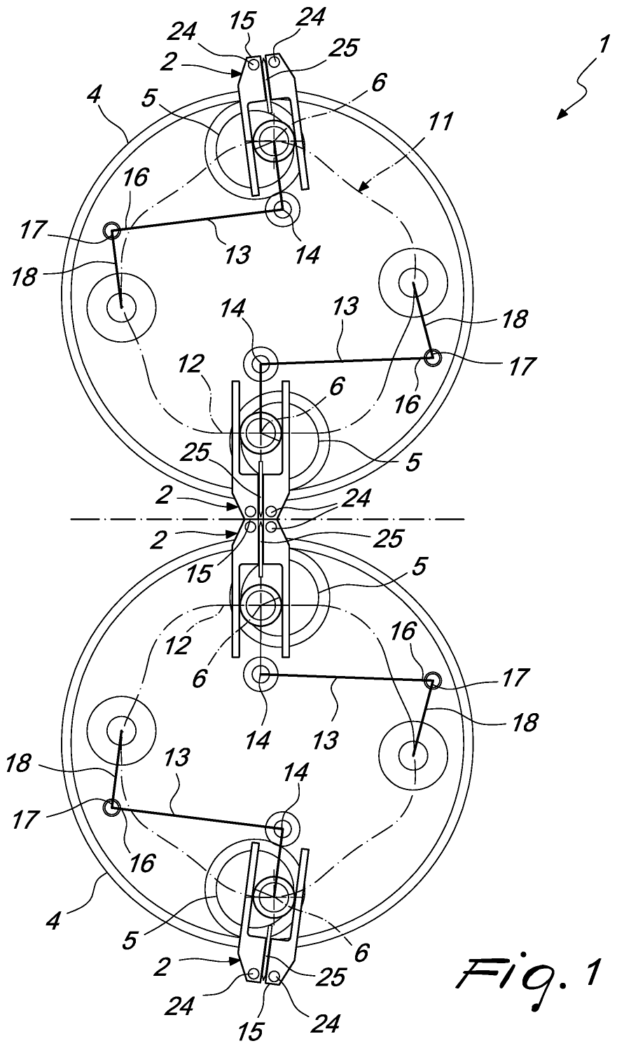

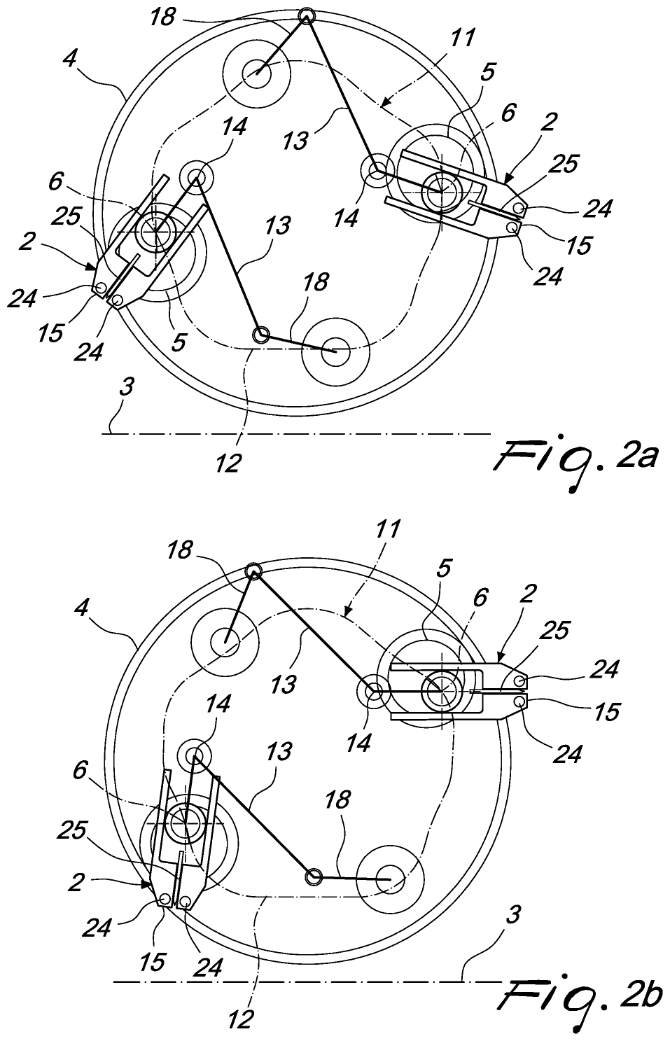

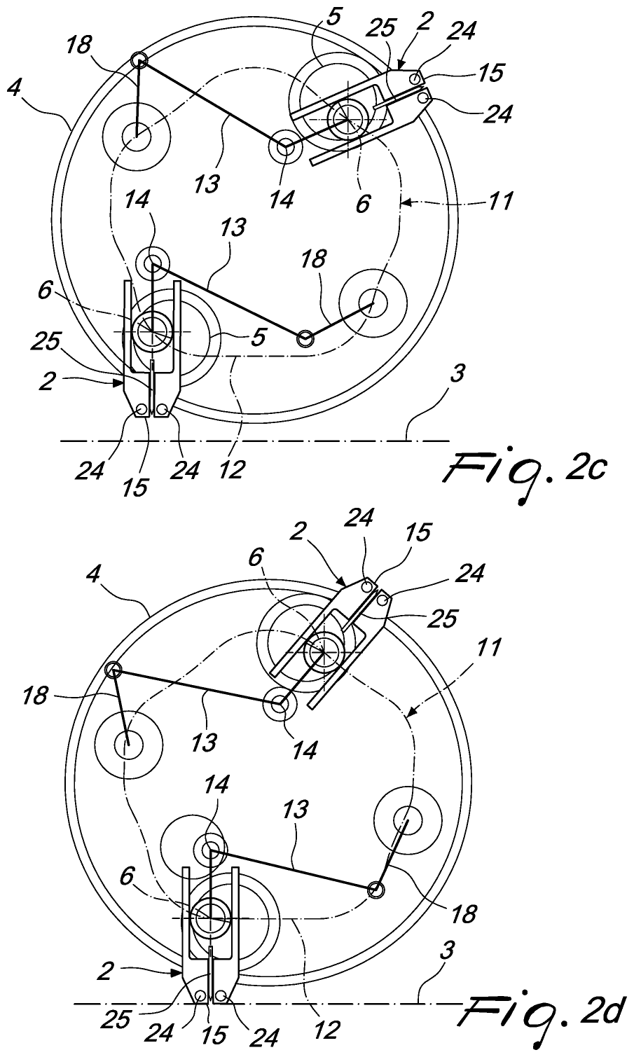

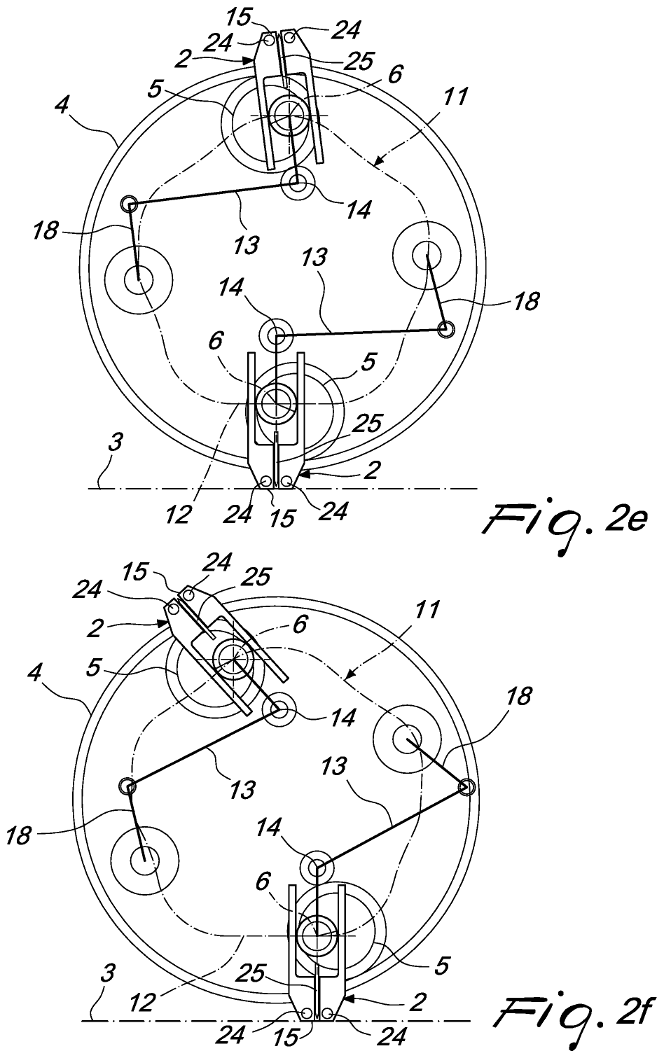

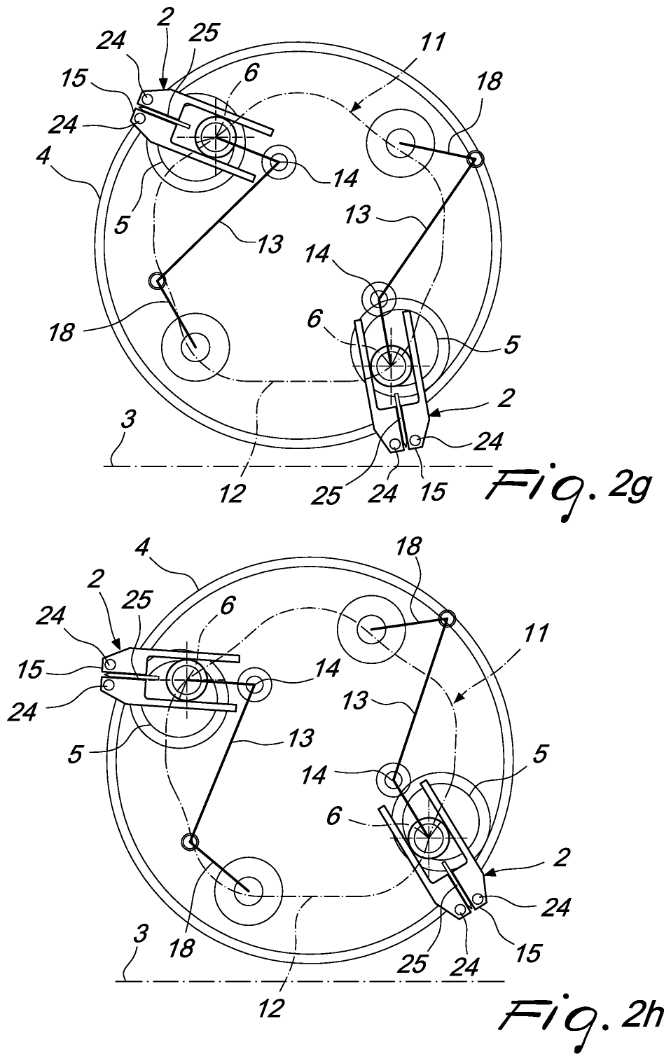

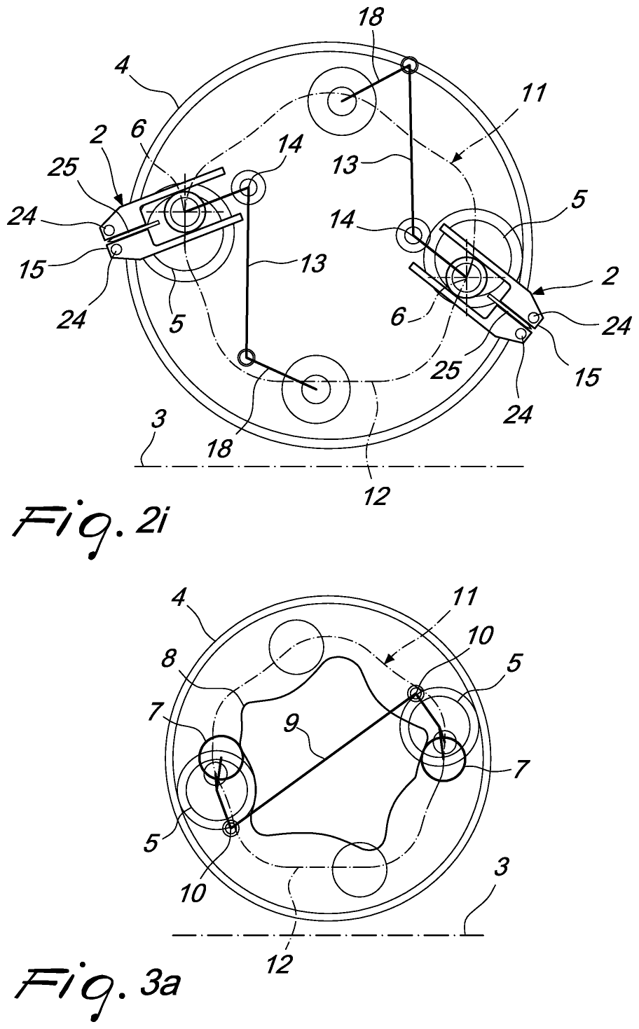

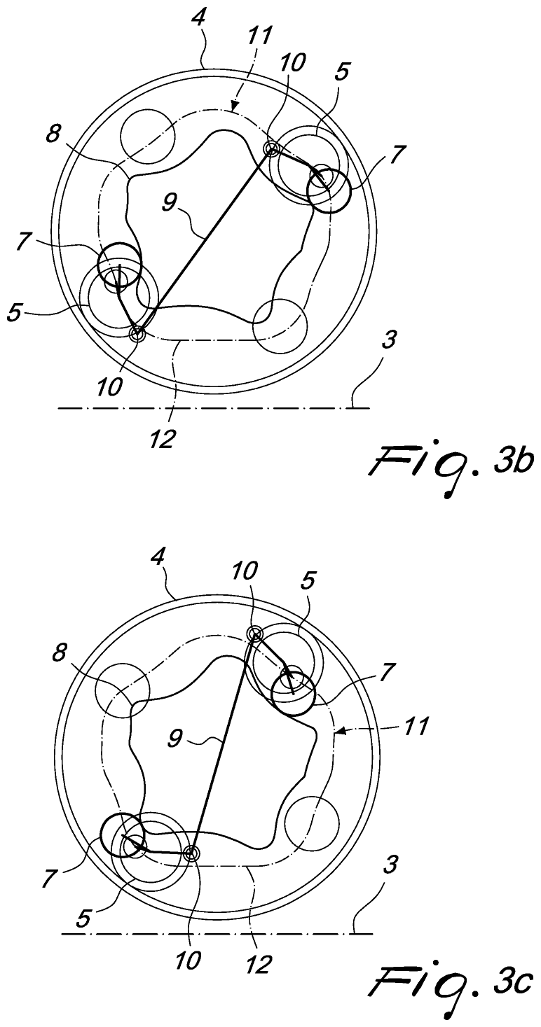

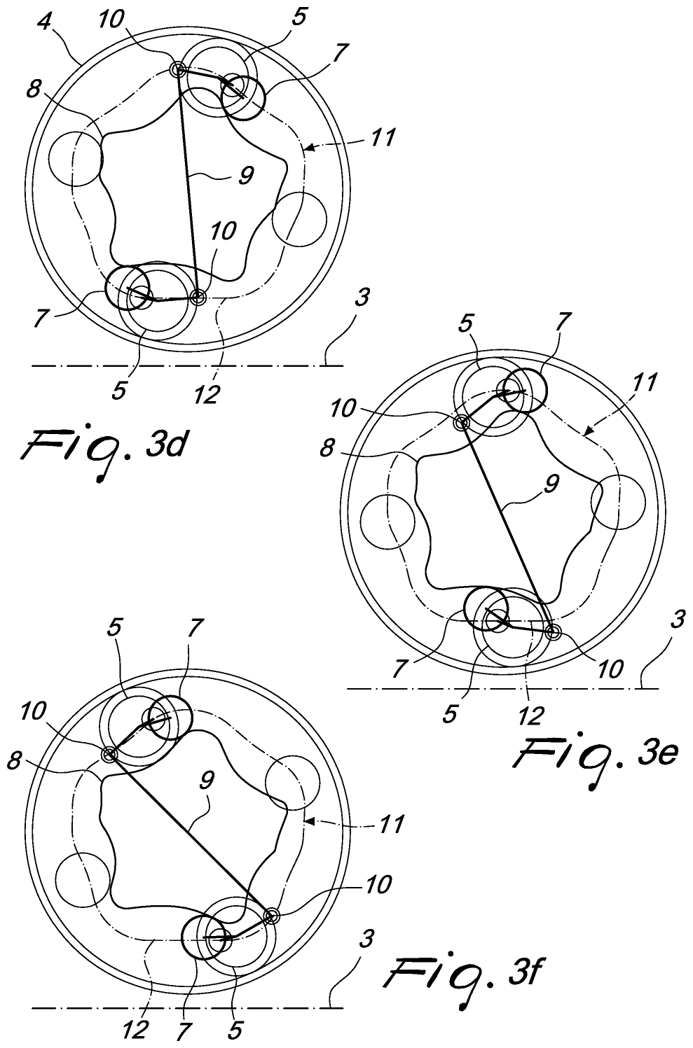

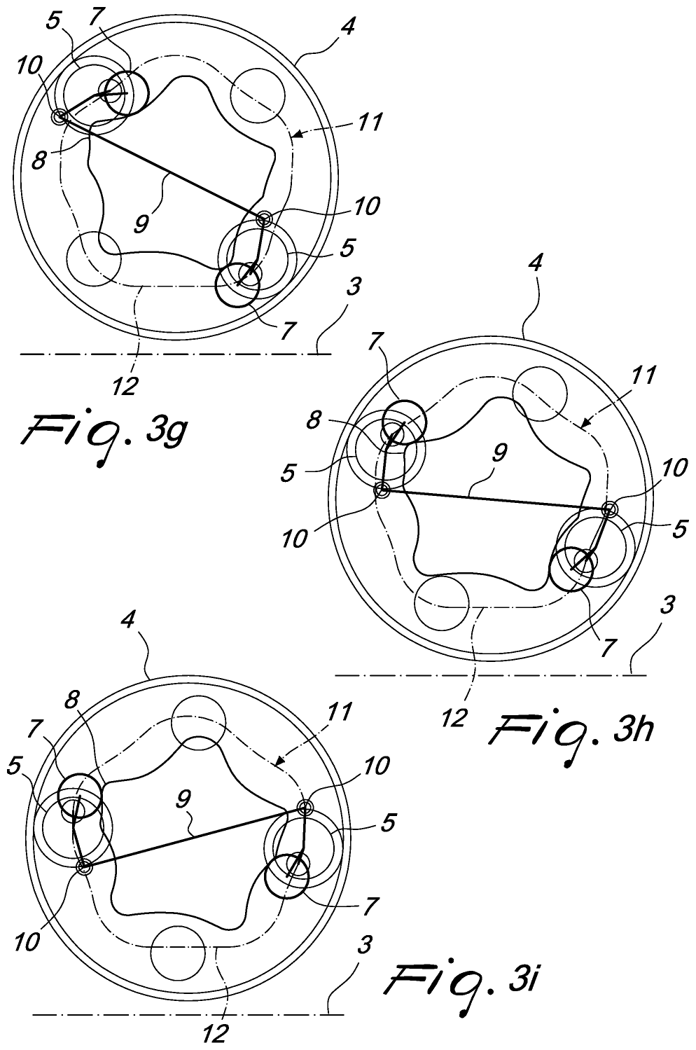

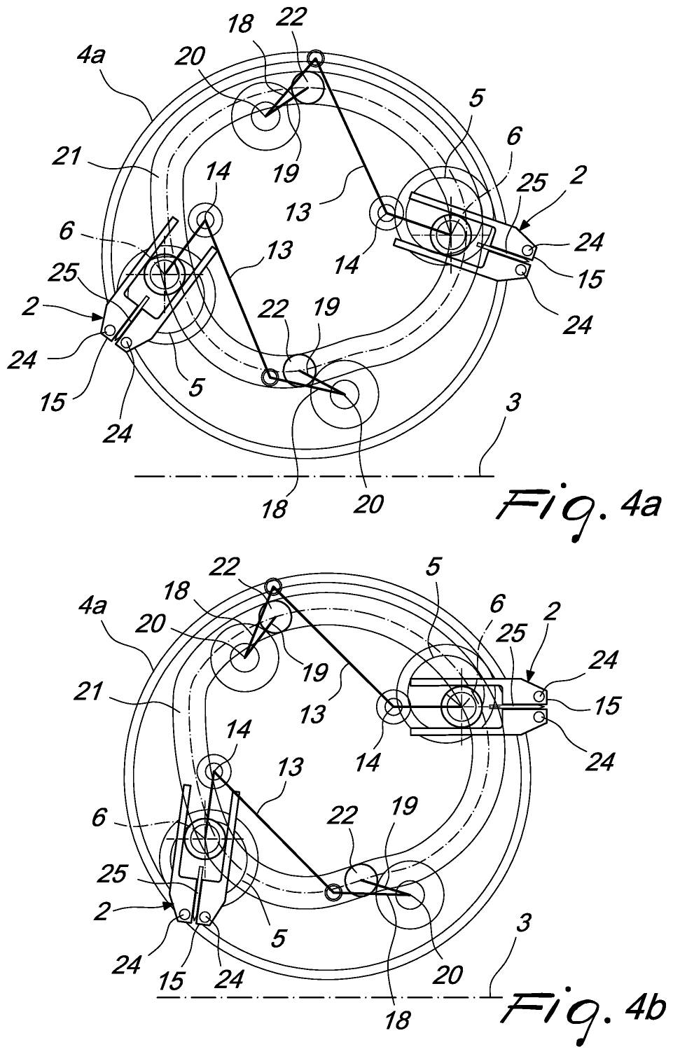

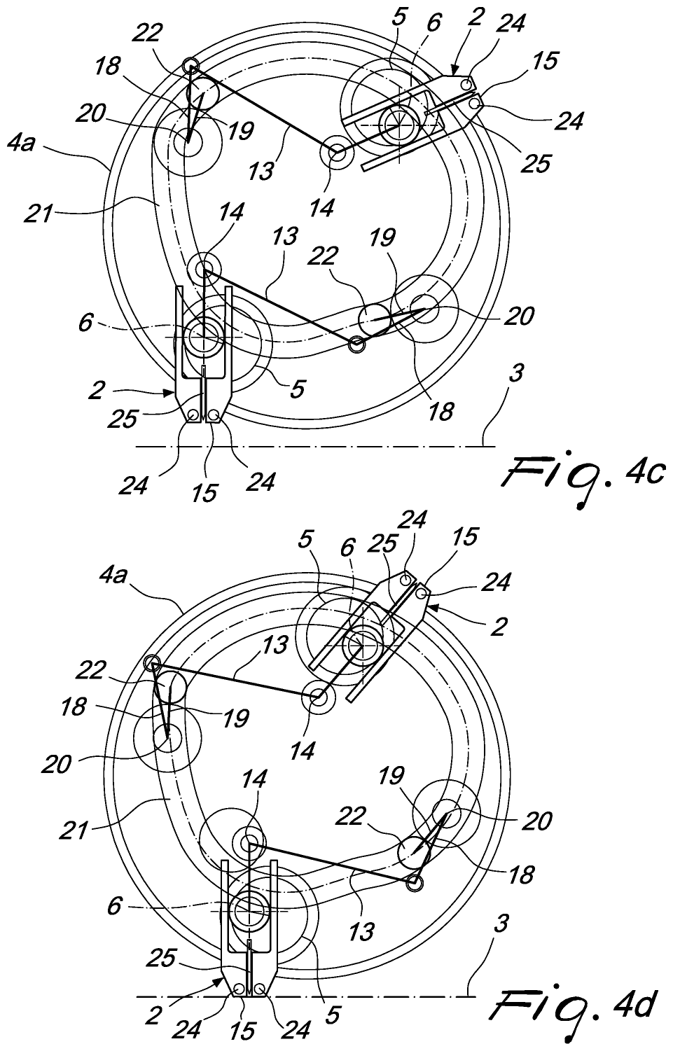

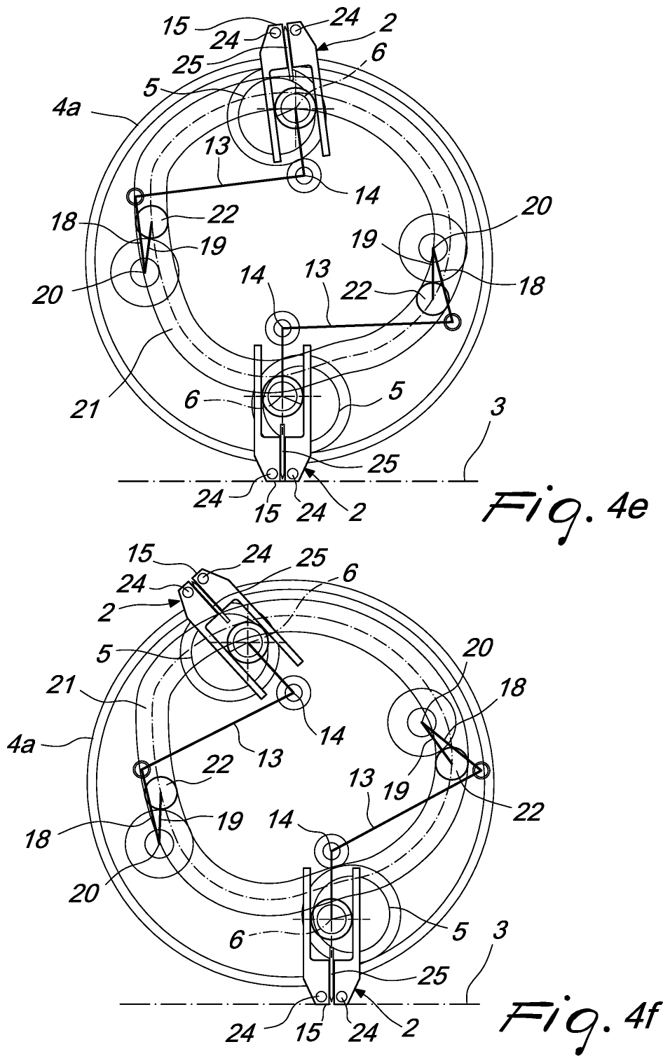

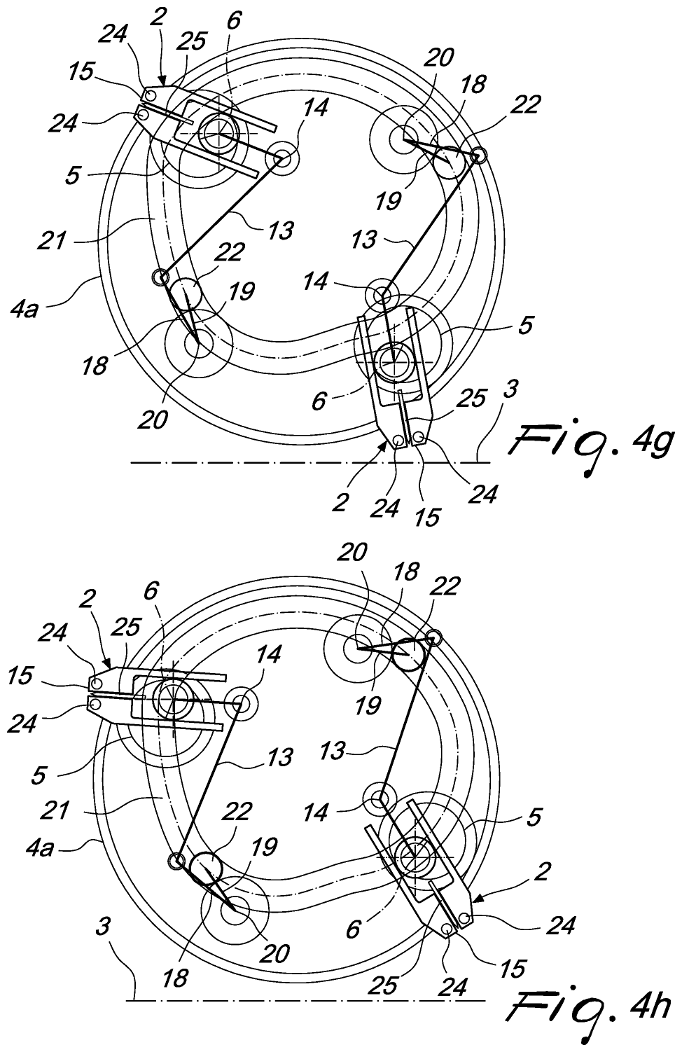

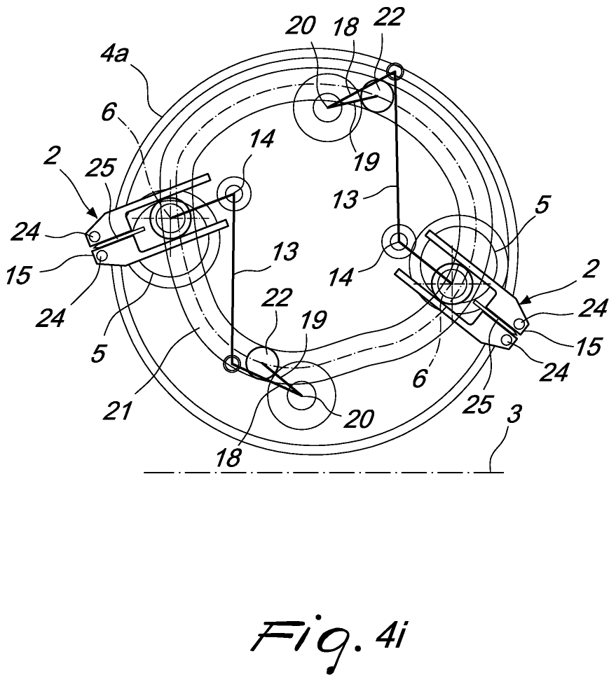

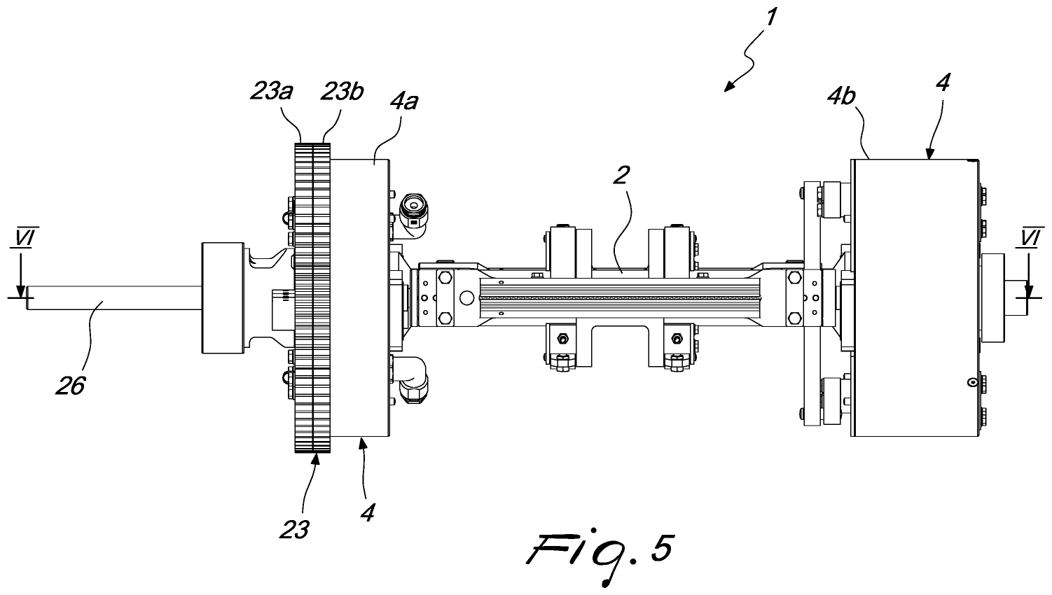

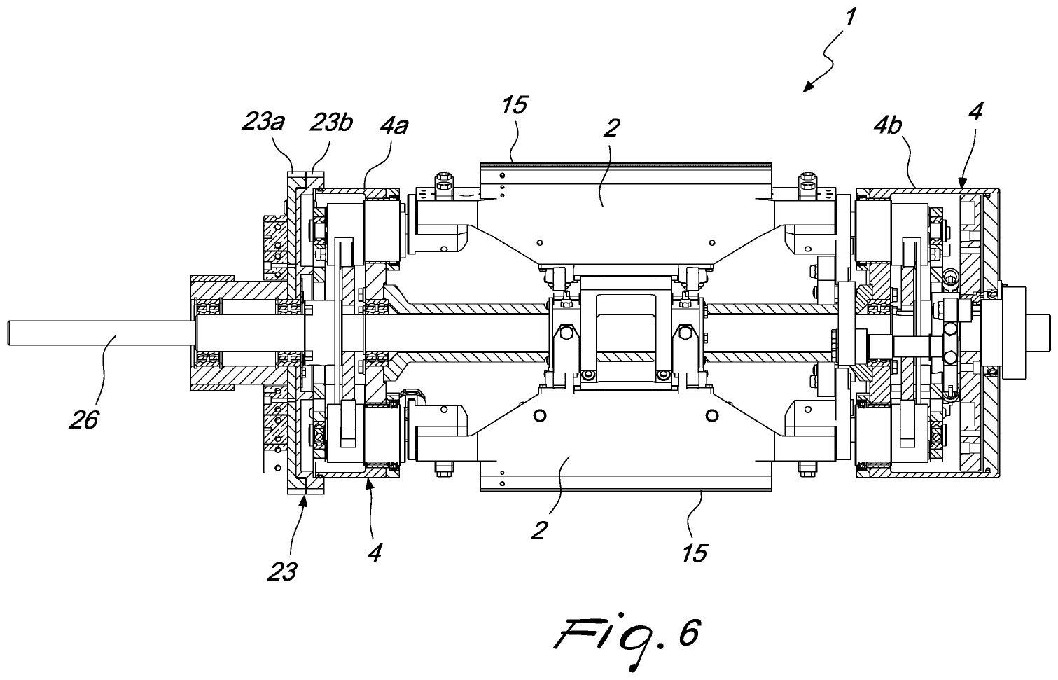

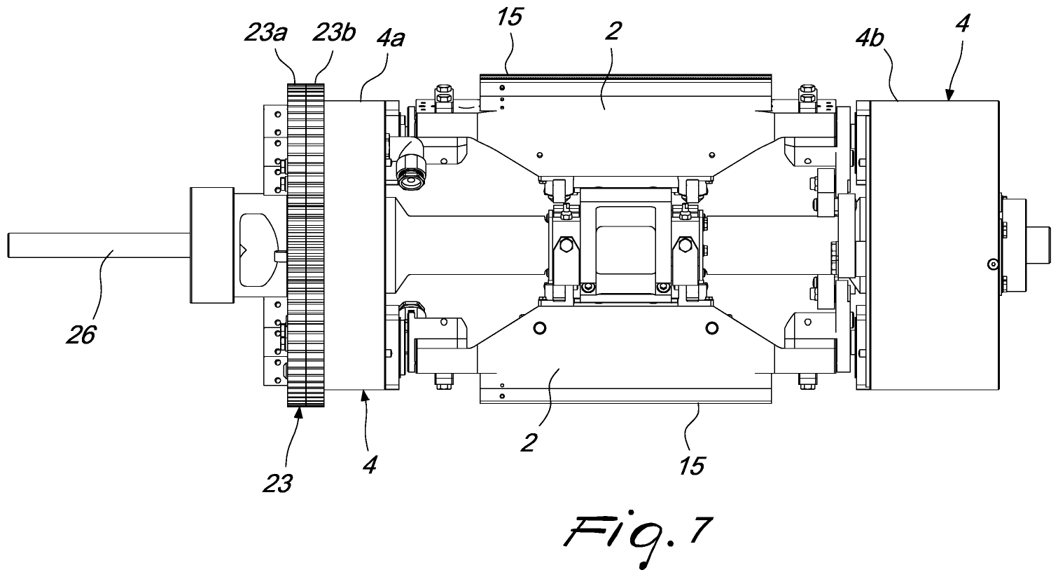

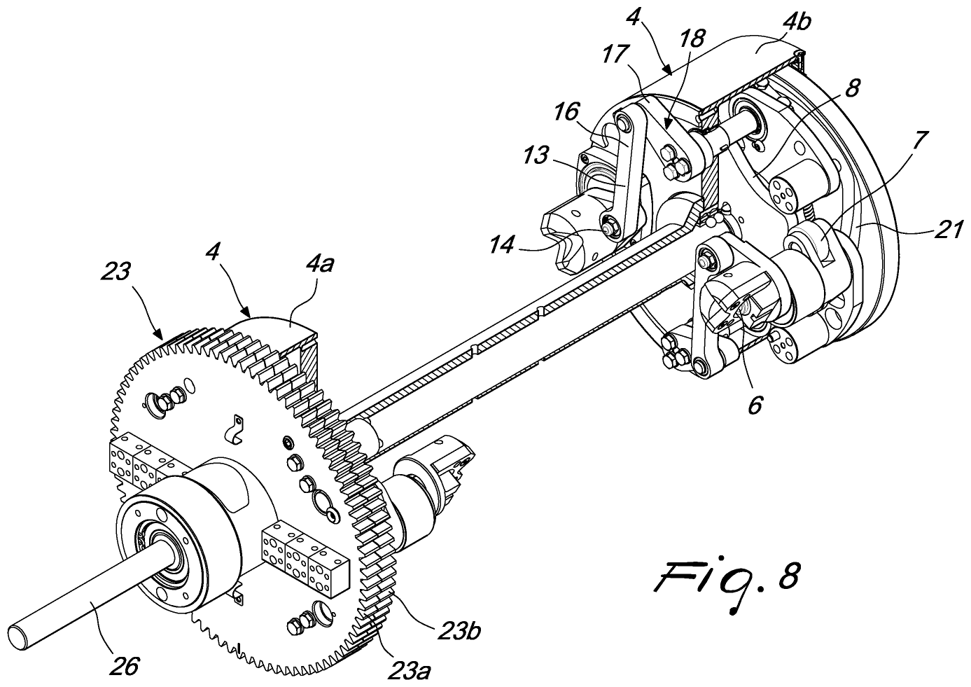

With particular reference to FIGS. 1-8 cited above, the numeral 1 generally designates a sealing assembly for packaging lines.

The sealing assembly 1 comprises mutually opposite sealing heads 2, between which the polymeric films to be mated translate along a trajectory 3.

The assembly 1 comprises mutually opposite and synchronously rotating carousels 4.

At least two eccentric shafts 5 are pivoted on each carousel 4, and a respective sealing head 2 is pivoted, at an axis 6, on each one of said shafts.

Each eccentric shaft 5 comprises in turn a respective slider 7 (for example a free roller, a wheel, a bearing or another component that is equivalent thereto) which is movable along a fixed contoured profile 8 (which has substantially the appearance of a fixed cam of the open type) for the movement of the respective eccentric shaft 5.

The slider 7 thus slides on a contoured profile 8, but this sliding configuration is not stable, since the profile 8 does not form any shoulder that avoids the spacing of the slider 7 from its surface. This is therefore an operating configuration in which the mechanism constituted by the slider 7 and the profile 8 is “labile” (or hypostatic).

In order to render this mechanism isostatic, a linkage 9 is adopted which connects corresponding levers 10 which are substantially integral with the eccentric shafts 5.

These levers 10 are substantially opposite with respect to the coupling point of the shaft 5 with the respective slider 7.

The particular structure described allows the sealing heads 2 (which can move by virtue of the action of the carousels 4) to trace a trajectory 11 which is provided with a region 12 that is parallel to the trajectory 3 (substantially juxtaposed thereon).

Finally, it is specified that each sealing head 2 is advantageously controlled by orientation elements which are integral with the respective carousel 4.

The orientation elements of each respective sealing head 2 comprise a first linkage 13 which is pivoted substantially at the end 14 that lies opposite the sealing end 15 of the sealing head 2.

The opposite end 16 of the first linkage 13 in turn is pivoted to a head 17 of a second lever 18.

The second lever 18 is integral with a lever 19 at the fulcrum 20.

The free front of said lever 19 (i.e., the one that lies opposite the one that is integral with the fulcrum 20 of the lever 18) can slide on a fixed cam 21.

This particular structure of the orientation elements of each sealing head 2 allows to keep the sealing end 15 of each head 2 facing and proximate to the end of the opposite head 2 (in a substantial mutual juxtaposition, with the interposition of the sheets of polymeric material) at the region 12, which is parallel to the trajectory 3, of the trajectory 11 traced by said heads 2.

It should be specified again that the axis 6, in which a sealing head 2 is pivoted to a respective eccentric shaft 5, upon a rotation of the carousels 4 defines the trajectory 11 provided with a linear portion (the region 12) at the sector of the carousels 4 that faces and is proximate to the polymeric sheets to be mated in transit.

The axis 6 is therefore the reference for identifying the type of movement performed by the sealing heads 2, independently of the movement imparted to the heads 2 by the corresponding orientation elements.

With particular reference to a constructive solution of unquestionable interest in practice and in application, the fixed cam 21 can be constituted conveniently by a slotted profile of the corresponding carousel 4.

The lever 19 accordingly comprises a protrusion 22 (for example a free roller or another component that is equivalent thereto) whose shape and dimensions are complementary to those of the shape of the slotted profile that constitutes the cam 21 for sliding on said profile.

In particular, it is noted that the fixed cam 21 on which the free front of the lever 19 (more specifically, the protrusion 22) slides is of the type of a desmodromic cam.

In order to define precisely the characteristics of a possible embodiment of the assembly 1 according to the disclosure, it is pointed out that the sealing heads 2 are two, face each other and are mutually proximate; each sealing head 2 is controlled by, and interposed between, two mutually opposite carousels 4, which in practice delimits it.

A first carousel 4a of the first head 2 advantageously comprises a gear 23 (which is optionally split into two single gears 23a and 23b) whose shape and dimensions are complementary to those of a gear of a first carousel of the second head (not completely identified in the accompanying figures).

The gears 23, during the operation of the assembly 1, must be mutually coupled for the synchronous motion of the first and second heads 2.

In particular it is specified that, as known in the field, it is possible to split a gear 23 into two individual gears 23a and 23b which are mutually identical to increase the precision of the meshing of the gear 23 associated with the upper sealing head 2 with the one associated with the lower sealing head 2.

By adjusting the initial position of the individual gears 23a and 23b it is in fact possible to reduce the actually available breadth of the slot delimited between their teeth, which is suitable to accommodate a respective tooth of the mutually opposite wheel.

This adjustment possibility ensures minimization of plays, with consequent increase in the synchronization of the movement between the upper head 2 and the lower head 2.

Each sealing head 2 comprises at least one unit 24 for heating at least one sealing end 15 and at least one blade 25 for cutting the polymeric sheets at their mating

The blade 25 is advantageously arranged proximate to the sealing end 15: with particular reference to the constructive solution shown by way of example in the accompanying figures, the blade 25 is interposed between two lateral portions of at least one respective sealing end 15.

When the two sealing ends 15 of mutually opposite heads 2 face each other and are substantially juxtaposed, the blade 25 of one of the two heads 2 abuts against the polymeric film, scoring it (cutting it) upstream and downstream of the seals being provided.

The possibility is not excluded to adopt a blade 25 at each sealing end 15: in this case the combined action of the two blades 25 will generate the cutting of the polymeric film.

With particular reference to an embodiment that allows to provide seals that are particularly stable and effective, it is specified that the sealing ends 15 might have an irregular shape (for example a partially undulated one) in order to affect a larger surface of polymeric film during sealing

It is noted that in order to ensure correct alignment, the assembly 1 can usefully comprise a central support and alignment shaft for the carousels 4 and the sealing heads 2.

The sealing heads 2 are two, face each other and are mutually proximate: each sealing head 2 is controlled by, and interposed between, two mutually opposite carousels 4, each of which comprises a respective eccentric shaft 5 provided with a slider 7 which can move along a fixed contoured profile 8 for its movement. The orientation elements are instead provided only in a respective carousel 4a.

The operation of the assembly 1 is as follows: upon the advancement of the sheets made of polymeric material to be sealed along their trajectory 3, a simultaneous movement of the eccentric shafts 5 occurs along the carousels 4 and is matched by a sliding of the slider 7 on the contoured profile 8 (the linkage 9 keeps the slider 7 in continuous contact on the surface of the profile 8).

This causes a movement of the sealing heads 2 along the trajectory 11.

Simultaneously, the first linkage 13 and the second lever 18 manage the orientation of the sealing head 2 owing to the sliding of the protrusion 22 (which is integral with the end of the lever 19 that is rigidly coupled to the end of the second lever 18) in the fixed cam 21 (of the slotted, desmodromic, and similar types).

In this manner, while the sealing heads move along the linear portion 12 of the trajectory 11, they are oriented in such a manner as to provide the juxtaposition of the sealing ends 15 of said two heads 2.

During the stroke that occurs along the linear portion 12, the polymeric sheets are thus sealed and cut. Sealing is performed in an optimum manner, since contact between the sealing ends 15 is extended over time and the pressure applied by one on the other is constant for the entire portion 12 of the trajectory 11.

Advantageously, the present disclosure solves the problems described earlier, proposing a sealing assembly 1 for packaging lines that ensures the execution of stable and complete seals. This is achieved by keeping the sealing heads 2 for an extended period of time in abutment against the polymeric sheets to be sealed and by applying, during this period of time, a pressure which is substantially constant (or in any case regular). The juxtaposition of the sealing ends 15 of the sealing heads 2 occurs over the entire (linear) portion 12 of the trajectory 11 traced by said heads 2 and therefore is extended over time.

Conveniently, the assembly 1 allows the line on which it is installed to work with high speeds and therefore with high productivity.

The portion 12 is in fact long enough to ensure optimum sealing even if the sheets advanced at high speed (the sealing end 15 remain substantially mutually juxtaposed for a time that is sufficient to stably mate the polymeric sheets).

Usefully, the assembly 1 according to the disclosure is particularly solid and scarcely subject to wear and failures. It in fact comprises exclusively mechanical components that are mutually controlled and are designed to generate substantially simple movements which provide for limited strokes.

Validly, the assembly 1 can be protected effectively against the accidental entry of dust and debris: the particular shape of the carousels 4 allows to cover them with appropriate protective housings, installing appropriate gaskets which isolate them from the outside environment, ensuring protection against the accidental entry of dust and solid objects.

Usefully, the sealing assembly 1 for packaging lines is relatively simple to provide in practice and has substantially modest costs: these characteristics make the assembly according to the disclosure an innovation of assured application.

The disclosure thus conceived is susceptible of numerous modifications and variations, all of which are within the scope of the appended claims; furthermore all the details may be replaced with other technically equivalent elements.

In the examples of embodiment shown, individual characteristics, given in relation to specific examples, may actually be interchanged with other different characteristics that exist in other examples of embodiment.

In practice, the materials used, as well as the dimensions, may be any according to the requirements and the state of the art.

The disclosures in Italian Patent Application No. 102017000020943 (UA2017A001226) from which this application claims priority are incorporated herein by reference.

1-9. (canceled)

10. A sealing assembly for packaging lines comprising mutually opposite sealing heads, between which the polymeric sheets to be mated translate, the sealing assembly comprising mutually opposite synchronously rotating carousels, at least two eccentric shafts being pivoted on each carousel, at least one respective sealing head being pivoted on each one of said shafts at an axis, each eccentric shaft comprising a respective slider configured to move along a fixed contoured profile for the movement of the respective shaft, a linkage connecting corresponding levers which are substantially integral with said eccentric shafts, said levers being opposite to the point of coupling to the respective slider, each sealing head being controlled by orientation elements which are integral with the respective carousel.

11. The sealing assembly according to claim 10, wherein said orientation elements configured for orientation of a respective sealing head comprise a first linkage pivoted substantially at an end that is opposite to a sealing end of said sealing head, an opposite end of said first linkage being pivoted to a head of a second lever, which is integral with a lever at a fulcrum, a free front of a lever being able to slide on a fixed cam.

12. The sealing assembly according to claim 10, wherein said axis, on which at least one sealing head is pivoted to a respective eccentric shaft, upon a rotation within said carousels traces a trajectory which is provided with a linear portion at the region of said carousels that faces and is proximate to said polymeric sheets to be mated, in transit.

13. The sealing assembly according to claim 11, wherein said fixed cam is constituted by a slotted profile of said carousel, said lever comprising a protrusion shaped and having dimensions which substantially correspond to a contour of the slotted profile of said cam for sliding thereon.

14. The sealing assembly according to claim 13, wherein said fixed cam on which the protrusion is a desmodromic cam.

15. The sealing assembly according to claim 10, wherein said sealing heads are two, face each other and are proximate, each sealing head being controlled by, and interposed between, two mutually opposite carousels, a first carousel of the first head comprising a gear having shape and dimensions complementary to a gear of a first carousel of the second head, said gears of the two mutually opposed carousels being mutually mated for a synchronous motion of the first and second heads.

16. The sealing assembly according to claim 10, wherein said sealing head comprises at least one unit configured for heating at least one sealing end and at least one blade for cutting the polymeric sheets upon their mating, said blade being arranged proximate to said sealing end.

17. The sealing assembly according to claim 10, further comprising a central support and alignment shaft for said carousels and said sealing heads.

18. The sealing assembly according to claim 10, wherein said sealing heads are two, face each other and are proximate, each sealing head being controlled by, and interposed between, two mutually opposite carousels, each comprising a respective eccentric shaft provided with a slider configured to move along a fixed contoured profile for a movement thereof, said orientation elements provided only in a respective carousel.
